(19) United States
(12) Patent Application Publication
(10) Pub. No.: US 2026/0049028 A1
(43) Pub. Date: Feb. 19, 2026

(54) CARBONIZED PRODUCT-CONTAINING GRANULES AND METHOD FOR PRODUCING THEM, AND USE

(71) Applicant: Fraunhofer-Gesellschaft zur Förderung der angewandten Forschung e.V., Munich (DE)

(72) Inventors: Christian KAISER, Valley (DE); VOGEL Sebastian, Valley (DE); Norbert LEISS, Valley (DE); Severin SEIFERT, Valley (DE)

(73) Assignee: Fraunhofer-Gesellschaft zur Förderung der angewandten Forschung e.V., Munich (DE)

(21) Appl. No.: 19/370,534

(22) Filed: Oct. 27, 2025

Related U.S. Application Data
(63) Continuation of application No. PCT/EP2024/062252, filed on May 3, 2024.

(30) Foreign Application Priority Data
May 5, 2023 (DE) 10 2023 204 198.7

(51) Int. Cl. C04B 14/02; C04B 18/02; C04B 18/10; C04B 20/00; C04B 20/10

(52) U.S. Cl. CPC C04B 14/022; C04B 18/021; C04B 18/101; C04B 20/008; C04B 20/1077; C04B 2201/50

(57) ABSTRACT

Granules are provided for building materials or as aggregates in building materials. Methods for producing the granules are also provided. The granules include a binder and a carbonized product, where the content of the carbonized product in each granule amounts to 30 wt.-% or more relative to the total weight of the binder and the carbonized product in the granule.

### CROSS-REFERENCE TO RELATED APPLICATIONS

This application is a continuation of international patent application PCT/EP2024/062252 filed May 3, 2024, which claims priority under 35 USC § 119 to German patent application DE 10 2023 204 198.7 filed May 5, 2023. The entire contents of each of the above-identified applications are hereby incorporated by reference.

### TECHNICAL FIELD

The invention relates to granules for use as building materials or as aggregates in building materials. The invention also relates to methods for producing the granules and the use thereof.

### BACKGROUND

The construction industry is an industrial sector with high CO₂ emissions. For example, the cement industry is one of the main emitters of greenhouse gases that cause global warming. Worldwide, 4.1 billion tons of cement are produced annually, containing an average of about 60% CaO. As a result, the release of carbon dioxide that is bound in lime, even in the case of optimum process control, leads to the emission of at least three billion tons of CO₂, or about 6 to 8% of the annual CO₂ emissions. For example, the production and use of 1 kg of Portland cement releases about 0.7 kg CO₂. In order to achieve the climate targets and reduce future costs in terms of CO₂ pricing, the CO₂ emissions in the building industry shall be reduced. One aspect of this is the search for alternative raw materials and substitution possibilities for particularly CO₂-intensive building materials.

One option which is known per se is the use of carbonized products in building products, as a result of which CO₂ can be bound in the form of carbon, thus allowing the building material to function as a carbon sink. However, the use of carbonized products in building materials is only possible to a limited extent due to their heterogeneous composition and the resulting irregular properties. Carbonized products from different sources or from different manufacturing methods also have different properties, which is why building material formulations should be constantly adapted. A large-scale industrial use is currently limited accordingly because the adaptation or modification of the residual materials (e.g. chemical treatment, conditioning, activation) is often complex and uneconomical. However, solutions need to be found to be able to incorporate carbonized products into building materials without disadvantages in order to curb the climate effects of the building industry and at the same time limit the costs due to the expected increase in CO₂ pricing.

There is therefore a lack of efficient, cost-effective homogenization and/or modification methods in order to adjust the carbonized products in regard to their properties or to optimize their connection to the building material matrices and then use this intermediate product in different building materials.

US 2020/0062646 A1 discloses building materials in which cement, sand and biochar are mixed and are hardened after the addition of water. Alternatively, powdered biochar is mixed with render or plaster and processed into coated or homogeneous pellets that can be used as fillers for drywalls. The disadvantage of this is that it was only possible with the disclosed methods to absorb very small amounts of biochar (about 6 g per 0.1 m² wall panel). Alternatively, it was possible to achieve in the mortar production just under 1.5 wt. % of biochar in the dry mass by replacing a small amount of sand with biochar. However, the employed biochar here first had to be ground after pyrolysis, which is an energy-intensive additional step that consumes additional energy and is thus also accompanied by further CO₂ emissions. The high specific surface area of the biochar is further increased by grinding, which allows it to adsorb more moisture. This has a strong influence on the workability of the mortar mixture, as a result of which superplasticizers had to be added to the mortar mixture for the purpose of compensation. In addition, the exact water requirement of the granules described in US 2020/0062646 A1 is initially unknown, depending on the origin of the carbonized products, and needs to be adjusted to the water content in a mortar mixture.

Therefore, the prior art presents a problem.

### SUMMARY

In one embodiment, the invention can provide granules comprising binders and carbonized products, the content of the carbonized product in the granules being 20 wt. % or more, based on the total weight of the binder and the carbonized product in the granule. It has been found that by mixing the binder and the carbonized product in a granular form, it is possible to easily provide homogeneous granular compositions that are suitable for further use in construction.

In one embodiment of the present invention, the binder in the granule is selected from the group of clinker cement, Portland cement, calcium aluminate cement, calcium sulfoaluminate cement, calcium sulfate (plaster), calcium oxide, calcium hydroxide, ash, fly ash, slag, slag sand, alkali metal or alkaline earth metal hydrides, halides, oxides, nitrates, sulfates, carbonates, silicates, phosphates, fluorides, or the organic derivatives thereof, such as alcoholates or acetates, aluminum phosphate compounds, aluminosilicates, clays, calcined alumina, kaolin, pozzolans, trass, tuff, organic polymers or combinations thereof. According to the invention, these binders are all suitable for being processed with carbonized products into granules, which can then be used in construction.

In a further embodiment of the present invention, the carbonized product is selected from the group of biochar, charcoal, pyrolyzed sewage sludge, pyrolyzed paper and/or pyrolyzed cardboard, pyrolyzed fermentation residues, industrial soot, and combinations thereof. According to the invention, carbonized products from the above-mentioned sources or manufacturing methods can be used throughout to form granules with binders, which can then be used in construction.

In a further embodiment of the present invention, the content of the carbonized product in the granule can be 30 wt. % or more, or 40 wt. % or more, or 50 wt. % or more, or 60 wt. % or more, or 65 wt. % or more, in each case on the basis of the total weight of the binder and the carbonized product in the granule. According to the invention, it is possible to produce, depending on the area of application, homogeneous granules with correspondingly high contents of carbonized product.

In a further embodiment of the present invention, the granule has a grain size in the range from about 0.1 mm to about 32 mm, or from about 0.2 mm to about 2 mm or from about 1.5 mm to about 5 mm or from about 5 mm to about 10 mm or from about 8 mm to about 20 mm or from about 20 mm to about 32 mm or from about 0.1 mm to about 1.5 mm or from about 20 mm to about 25 mm or from about 25 mm to about 32 mm. For granules comprising a plurality of granules according to the invention, this shall ensure an average grain size in the range from 0.1 mm to 32 mm. Corresponding grain sizes are best suited for use in construction.

In a further embodiment of the present invention, the granule is homogeneous. In this context, one speaks of a homogeneous granule if the binder and carbonized product are evenly distributed within the granule. In this sense, an even distribution exists if the carbonized product grains are distributed within a binder matrix in the granule in such a way that there are no regions having carbonized product contents that deviate significantly from the average content.

In an alternative embodiment of the present invention, a granule can be layered. In this respect, a layered structure is said to exist when, for example, the core of the granule consists exclusively of a binder or exclusively of a carbonized product and the core is covered by a layer of the respectively other component. Multiple layer sequences are also considered to be a layered structure. In particular, depending on the area of application of the granules, it may be desirable for there to be a binder layer on the surface of the granules.

In one embodiment of the present invention, the granule substantially consists of a carbonized product and a binder. This is the case if, with the exception of water, no other component is present in the granule in an amount of 5 wt. % or more.

In one embodiment of the present invention, the granule has a loss on ignition, measured pursuant to DIN 18128, of 15% or more. In other embodiments of the present invention, the granule has a loss on ignition, measured pursuant to DIN 18128, of more than 20% or more than 30% or more than 50% or more than 60% or more than 70%. In particular, this can be used to prove that oxidizable carbon in the form of carbonized product is present in the granules according to the invention and, accordingly, to provide evidence of CO₂ binding.

A method for producing granules that comprises granules of the present invention is also part of the present invention, the manufacturing method including method steps which are selected from wet granulation, spray drying, fluidized bed granulation, melt granulation, or combinations thereof. It has been shown that granules according to the invention can be obtained using a variety of manufacturing methods.

In one embodiment of the manufacturing method according to the invention, a first step involves the carbonation of biomass, plant material, wood, sewage sludge, paper, cardboard, fermentation residues, or combinations thereof. This step is followed by the addition of a binder and directly downstream granulation.

In a further embodiment of the manufacturing method according to the invention, after or during carbonation, the carbonized product is ground, and optionally sieved so that the carbonized product has a particle size distribution such that d₈₀≤500 μm or d₈₀≤100 μm.

Furthermore, part of the present invention is the use of granules containing the granules according to the invention or granules which are produced according to the method of the invention as an aggregate in building materials, bulk insulation, an aggregate in dry mortar products, acoustic components, an aggregate in acoustic absorbers, an addition to crash concrete, colorant, an aggregate for improving the flow properties in flowable building materials, an aggregate for asphalt, filler, plant substrate, an aggregate for backfill concrete, joint filling, palisades, bedding material, tree disks or grates, granules for dike or dam construction, greening for roofs and facades, catalysts or carrier material for catalysts, filter/sorption, filter material for exhaust gases or liquid waste streams, drying agents, absorbers for contaminants or pollutants or combinations thereof. It has been shown that the granules according to the invention are widely applicable and suitable for the aforementioned applications.

### BRIEF DESCRIPTION OF THE DRAWINGS

The invention will now be explained in more detail with reference to drawings, without limiting the general concept of the invention.

FIG. 1 shows a selection of composite granules having different grain sizes, obtained according to the exemplary embodiment;

FIG. 2 shows a micro-CT image of granules before and after 7 days of water storage;

FIG. 3 shows a graphical representation of the compressive strengths after 28 days of the mortar formulations from the following examples; and

FIG. 4 shows a graphical representation of the flexural strengths after 28 days of the mortar formulations from the following examples.

### DETAILED DESCRIPTION

The invention will now be described in detail with reference to exemplary embodiments thereof and to the drawings.

The present invention proposes a new solution for homogenizing and adjusting carbonized products so that they can be used to a greater extent in building materials. The aim is to use, on the basis of heterogeneous starting materials, granulation to provide a homogeneous product for use in the form of CO₂-negative composite granules.

This object is achieved by combining preferred mineral materials (such as cement, quicklime, slag sand, fly ash, limestone, kaolin, alumina, etc.) with one or more carbonized products. This allows a homogeneous product to be produced, the interaction shell of which can be adapted to the corresponding building material matrix. The combination is achieved by means of granulation. The granules, on the other hand, have a smaller surface area than pure coal particles and therefore require less water. Compared to pure pyrocarbon, their use in mortar leads to a less significant reduction in flow properties when fresh and therefore requires significantly fewer adjustments.

The granules according to the invention can basically be used as a sand substitute in mortar or concrete. In this context, it is possible to replace natural aggregates with spherically shaped and dimensionally stable granules that consist of cement stone and coal and have adjustable grain sizes with diameters in the range of >0 to 32 mm. This allows components to be manufactured with almost identical strength as in references without the substitution of natural sand.

In different embodiments of the present invention, the granules can here be uniformly structured or contain different layer sequences. It is here possible to adjust, due to targeted coating during the granulation process, a wide variety of surface properties on the granules (e.g. hydrophobicity, hydrophilicity, roughness, specific surface area, etc.), which can interact in different ways with a binder matrix to define the properties throughout the component. These properties can be individually adjusted during the granulation and adapted or optimized for the respective application. Depending on the application, the content of the carbonized product in the granules according to the invention can be adjusted to 70 wt. % or more.

In some embodiments of the present invention, the granules obtained are emission-free or even CO₂-negative in terms of their material CO₂ balance and thus have a negative emission effect on a material, into which the granules according to the invention are introduced.

The granules according to the invention make it possible to treat carbonized products independently of their origin for unrestricted use in building material systems. All known variations can be used as carbonized products, in particular biochar, charcoal, pyrolyzed sewage sludge, pyrolyzed paper and cardboard, pyrolyzed fermentation residues, industrial soot, and combinations thereof.

The granules according to the invention render possible that the carbon content of the carbonized product, which is obtained, for example, from biomass by pyrolysis, compensates for the CO₂ emissions of the added components (e.g. mineral binders such as Portland cement). For example, the production and use of 1 kg of Portland cement releases about 0.7 kg of CO₂. On the other hand, the production of 1 kg of carbonized product having up to 99% carbon binds about 3.67 kg CO₂. Thus, 191 g of carbonized product can mathematically compensate for the CO₂ emissions of one kilogram of Portland cement.

The binding of CO₂ in the granules according to the invention is also proven by a loss on ignition, measured pursuant to DIN 18128, in the range of 15% or higher.

Furthermore, it has been found that, in contrast to powdered carbonized products, the granules according to the invention do not emit carbon dust during transport, storage, and handling, thus offsetting the disadvantages in terms of occupational health or explosion hazard. This means that the granules according to the invention can also be stored in silos and can be more easily conveyed and dosed during filling, packaging, and use.

Another advantage of the granules is their moisture-regulating property due to reversible water or moisture absorption and release. The capacity can be adjusted by selecting the materials/raw materials, in particular the carbonized products, as well as the process parameters and thus the size, density, and porosity.

The dimensional stability achieved by the granules according to the invention is a basic prerequisite for further use in various building materials. Due to the water absorption capacity of biochar, volume increases could also occur. Swelling of individual components in building materials is usually associated with difficulties, so that any swelling behavior of the granules plays a decisive role and must be prevented accordingly. In contrast to free carbon, the granules according to the invention prevent swelling to such an extent that they can be used in building materials in accordance with the standards.

Possible methods for homogenization are wet granulation, spray drying, alternatively fluidized bed or melt granulation.

In the preferred wet granulation process, a liquid, usually water, is added to the powder mixture discontinuously or continuously during the ongoing mixing process. If a binder is used, it can be added as a solid or liquid.

The fluidized bed process is similar to wet granulation.

In melt granulation, the binder is liquefied by elevated temperature during granulation before the resulting granules harden again at ambient temperature.

It has been found that the different methods described above make carbonized products suitable for use in building material systems without restriction, regardless of their origin and manufacturing method. It has also been shown that the amount of carbonized products used in building materials is no longer limited by their material properties, thus achieving a higher filling degree and maximizing the climate-positive effect.

The granules according to the invention can be used in a wide range of applications. These include construction applications, gardening and landscaping, and the use as functional carrier particles.

In the field of construction, the granules according to the invention can be used as an aggregate for building materials, bulk insulation, an aggregate in dry mortar products, acoustic components, an aggregate for acoustic absorbers, an addition to crash concrete, colorant, an aggregate for improving the flow properties of flowable building materials, an aggregate for asphalt, or as fillers.

In gardening and landscaping, the granules according to the invention can be used as a plant substrate, aggregate for backfill concrete, joint filling, palisades, bedding material, tree disks or grates, granules for dike or dam construction, or in greening for roofs and facades.

The use of the granules according to the invention as carriers is conceivable as catalysts or carrier material for catalysts, in filter/sorption systems, as filter material for exhaust gases or liquid waste streams, as drying agents, or as absorbers for impurities or contaminants.

A part of the present innovation also includes any combinations of features and/or delimitations described herein, insofar as they are not mutually exclusive. The description of the innovation relates to certain embodiments of the innovation with the aim of illustrating them. A person skilled in the relevant art will recognize that further modifications and equivalents of the embodiments described here are possible. Modifications and equivalents of this type also form part of the overall scope of the described innovation.

### Example 1

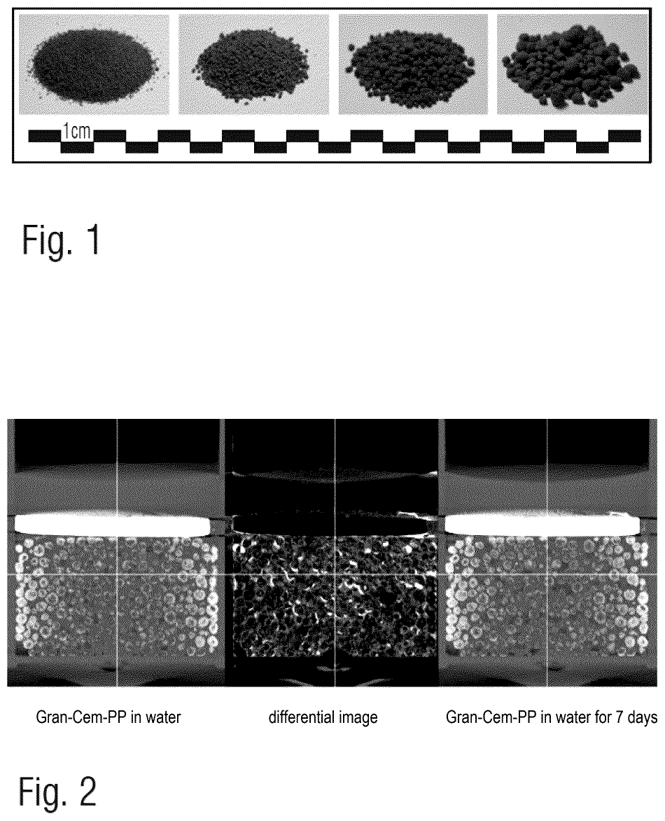

Portland cement-bound granules made from a carbonized product (charcoal having a carbon content of 90-92 wt. %) was produced as follows: 1 kg of Portland cement (42.5 N) was mixed with 2 kg of charcoal in a mixer with the addition of 1.65 kg of water to produce moist granules. Depending on the time and speed, granules with different grain sizes were obtained, as shown in FIG. 1.

Regardless of the grain size of the granules, the material CO₂ balance is calculated as follows. 1 kg of cement (OPC) emits about 0.7 kg CO₂ and 2 kg of coal (carbonized product consists of about 91% carbon) binds about 6.68 kg of CO₂—In the balance, this formula binds 5.98 kg CO₂ in the form of carbon in relation to binder and coal. Accordingly, about 1.99 kg CO₂ is bound per kg of granules. In this calculation, the added water was not included in the mass balance.

After storing the resulting granules in water for 7 days, it was found that the size of the granules remained stable. This is illustrated in FIG. 2. The deviations in the difference image (center) are due to fine particles that moved during storage.

### Example 2

Example 2 concerns the production of mortar formulations using the granules according to the invention. A standard mortar formulation was used to test the influence when partially replacing sand with biochar or the granules according to the invention. The standard mortar formulation (reference example RB1) consisted of 450 g cement, 1350 g sand, and 225 g water. In the comparative examples VB1 and VB2 and the examples EB1 and EB2 of the invention, 5 and 10 wt. % of sand, respectively, were replaced by identical masses of coal or the granules according to the invention. Table 1 summarizes the mortar compositions of the reference as well as the comparative examples and examples of the invention (without water).

TABLE 1

| | RB | | VB1 | | VB2 | | EB1 | | EB2 | |
|---|---|---|---|---|---|---|---|---|---|---|
| Cement (CEM 1 42.5) | 450 | g | 450 | g | 450 | g | 450 | g | 450 | g |
| Sand | 1350 | g | 1282 | g | 1215 | g | 1282 | g | 1215 | g |

| | | | | | | | |
|---|---|---|---|---|---|---|---|
| Coal (L7307) | 0 | 68 | g | 135 | g | 0 | 0 |

| | | | | | | | |
|---|---|---|---|---|---|---|---|
| Granules (Example 1) | 0 | 0 | 0 | 68 | g | 135 | g |

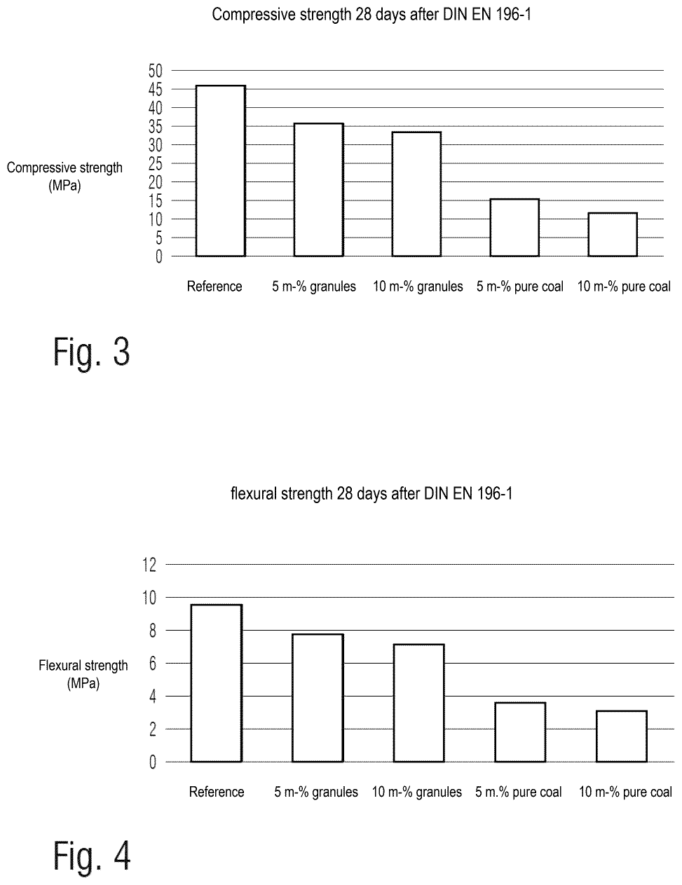

The formulations produced were used in mortar prisms and tested 28 days after their production for compressive strength (DF) or flexural strength (BZF) in accordance with DIN EN 196-1. In addition, the CO₂ balances of the formulations were calculated. The results are shown in Table 2 and FIGS. 3 and 4. For the calculation of the CO₂ balance, values of +0.7 kg CO₂ per kg of cement, 3.34 kg CO₂ per kg of coal, and −1.99 kg CO₂ per kg of granules were assumed as a basis. Sand is assumed to be CO₂-neutral.

TABLE 2

| | RB | | VB1 | | VB2 | | EB1 | | EB2 | |
|---|---|---|---|---|---|---|---|---|---|---|
| CO₂ balance | 0.315 | kg | −0.09 | kg | −0.135 | kg | 0.18 | kg | 0.046 | kg |
| Volumes | 1.242 | L | 1.581 | L | 1.830 | L | 1.384 | L | 1.475 | L |
| CO₂ balance per m³ | 253.6 | kg | 56.9 | kg | −73.8 | kg | 130.1 | kg | 31.2 | kg |
| DF | 46 | MPa | 15 | MPa | 12 | MPa | 36 | MPa | 33.5 | MPa |
| BZF | 10 | MPa | 4 | MPa | 3 | MPa | 8 | MPa | 7 | MPa |

The substitution of sand with both granules and pure coal leads to a reduction in compressive and flexural strength in the mortar test prisms compared to the reference with pure quartz sand. Compared to the addition of the granules, the addition of pure coal resulted in significantly lower compressive and flexural strength as well as a significantly greater reduction in workability. In order to adjust the flow properties, additional water was added to both the granules and pure coal mixtures. This resulted in a comparatively higher w/c ratio in the formulation, which ultimately led to a decrease in strength in the mortar prisms. In the formulations with loose coal as a sand substitute, the workability was significantly worse than in the mortar that contains granules, which is why the water requirement was significantly higher in these formulations. This explains the significantly lower strength values in the comparison.

By partially replacing sand with granules, it was possible to drastically improve the CO₂ balance of the mortar formulations, while the losses in mechanical properties remained within an acceptable range. In contrast, the use of coal achieved an even better CO₂ balance, but the mortar formulations obtained had unacceptable mechanical properties. Due to the lower bulk density of the granules compared to coal, the resulting mortar formulations also have a lower density.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

Of course, the invention is not limited to the described embodiments. Therefore, the above description should not be regarded as limiting but as explanatory. The following claims should be understood as meaning that an indicated feature is present in at least one embodiment of the invention. This does not exclude the presence of further features. The following claims should not be understood as meaning that an indicated feature or an indicated combination of features is present in every embodiment of the invention. Insofar as the claims and the above description define “first” and “second” embodiments, this designation is used to distinguish between two similar embodiments without establishing an order of priority.

What is claimed is:

1. A granule comprising a binder and a carbonized product, wherein the content of the carbonized product in the granule is 30 wt. % or more, relative to a total weight of the binder and the carbonized product in the granule.

2. The granule of claim 1, wherein the binder is selected from the group consisting of clinker cement, Portland cement, calcium aluminate cement, calcium sulfoaluminate cement, calcium sulfate (plaster), calcium oxide, calcium hydroxide, ash, fly ash, slag, slag sand, alkali metal or alkaline earth metal hydrides, halides, oxides, nitrates, sulfates, carbonates, silicates, phosphates, fluorides or their organic derivatives, alcoholates, acetates, aluminum phosphate compounds, aluminosilicates, clays, calcined alumina, kaolin, pozzolans, trass, tuff, organic polymers, and any combination thereof.

3. The granule of claim 1, wherein the carbonized product is selected from the group consisting of biomass, biochar, charcoal, pyrolyzed sewage sludge, pyrolyzed paper and cardboard, pyrolyzed fermentation residues, industrial soot, and any combination thereof.

4. The granule of claim 1, wherein the content of the carbonized product in the granule is 40 wt. % or more relative to the total weight of the binder and the carbonized product in the granule.

5. The granule of claim 1, wherein the granule has a grain size in the range from 0.1 mm to 32 mm.

6. The granule of claim 1, wherein the granule is homogeneous.

7. The granule of claim 1, wherein the granule has layers of different structures.

8. The granule of claim 7, wherein the carbonized product is located in the core of the granule and the binder is located on the surface of the granule.

9. The granule of claim 1, wherein the granule consists substantially of the binder and the carbonized product.

10. The granule of claim 1, wherein the granule has a loss on ignition of 15% or more, measured pursuant to DIN 18128.

11. The granule of claim 1, wherein the content of the carbonized product in the granule is 50 wt. % or more relative to the total weight of the binder and the carbonized product in the granule.

12. The granule of claim 1, wherein the content of the carbonized product in the granule is 60 wt. % or more relative to the total weight of the binder and the carbonized product in the granule.

13. The granule of claim 1, wherein the content of the carbonized product in the granule is 65 wt. % or more relative to the total weight of the binder and the carbonized product in the granule.

14. The granule of claim 1 included in an aggregate for building materials, a bulk insulation, an aggregate in dry mortar products, an acoustic component, an aggregate for acoustic absorbers, an addition to crash concrete, a colorant, an aggregate for improving the flow properties in flowable building materials, an aggregate for asphalt, filler, a plant substrate, an aggregate for backfill concrete, a joint filling, palisades, a bedding material, tree disks or grates, a dike or dam construction, a greening for roofs and facades, a catalyst or a carrier material for a catalyst, a filter/sorption, a filter material for exhaust gases or liquid waste streams, a drying agent, an absorber for impurities or contaminants, or any combination thereof.

15. A method for producing a plurality of granules, the method comprising producing the granules by wet granulation, spray drying, fluid bed granulation, melt granulation, or any combination thereof, wherein each of the granules comprises a binder and a carbonized product, wherein a content of the carbonized product in each respective one of the granules is 30 wt. % or more, relative to a total weight of the binder and the carbonized product in the respective one of the granules.

16. The method of claim 15, wherein in a first step, plant material, sewage sludge, paper, cardboard, fermentation residues, or combinations thereof are carbonated, and the first step is followed by the addition of the binder and granulation immediately thereafter.

17. The method of claim 16, wherein after or during the carbonation, the carbonized product is ground and optionally sieved so that the carbonized product has a particle size distribution such that d₈₀≤500 μm or d₈₀≤100 μm.
